(19) United States
(12) Patent Application Publication
(10) Pub. No.: US 2023/0356180 A1
(43) Pub. Date: Nov. 9, 2023

(54) SORBENT FOR REMOVAL OF IONS FROM LIQUID STREAMS AND METHOD OF MAKING THE SAME

(71) Applicant: Graver Technologies LLC, Glasgow, DE (US)

(72) Inventors: Joshua Mertz, Townsend, DE (US); Alexander Kronfeld, North East, MD (US); Bridgett Harris, Elkton, MD (US)

(21) Appl. No.: 18/310,905

(22) Filed: May 2, 2023

Related U.S. Application Data
(60) Provisional application No. 63/337,830, filed on May 3, 2022.

(51) Int. Cl. B01J 20/10; B01J 20/28; C02F 1/28

(52) U.S. Cl. CPC B01J 20/10; B01J 20/28071; C02F 1/281; C02F 2101/20

(57) ABSTRACT

A sorption media with a high capacity to remove heavy metals, lead, and mercury, in particular when synthesized from a titanium source that contains sulfur, such as black liquor or titanyl sulfate (TiOSO₄). The use of sulfur provides a higher than expected capacity for Pb and/or Hg. A Group 1 and/or Group 2 metal-titanosilicate is employed, having a Ti to Si molar ratio of 0.5-2, a pore volume of at least less than or equal to 0.25 cc/g.

### BACKGROUND OF THE INVENTION

This invention relates to a novel sorbent (ion exchange or adsorbent) media capable of removing cations from liquids streams, particularly divalent heavy metal cations from water.

The use of sorption media (adsorption, ion-exchange, absorption) both inorganic and organic has been long known in the art. The technical and patent literature has significant examples of the wide array in which these materials are synthesized, used, and combined to remove metals and other contaminants from water. Ion exchange materials trade one ion for another, based on stoichiometry and charge. Ion exchange materials are used in many applications both to treat wastewater and to treat drinking water. Some sorbent material may be inorganic in nature. Some are pure ion-exchangers while others do physi- or chemi-sorption.

A practical use of the above materials is in point of entry (POE) or point of use (POU) water filters for homes. Water softeners, for example, use ion exchange to replace calcium ions (Ca²⁺) and magnesium ions (Mg²⁺) in tap water with two sodium ions (2Na⁺) per contaminant exchanged. The materials have a finite capacity for hard ions. When exchange no longer occurs, the bed is either regenerated with concentrated salt, or disposed. Traditional water softeners are regenerated, sometimes daily, with salt to provide calcium reduced water to homes, protecting home appliances and equipment.

In evaluating the properties of a sorbent, it is crucial to fully understand the environment in which the media will remove unwanted contaminants. Competitive ions (chemical pressure), pH, flow rate (kinetics), all affect the ability of sorption media to remove specific contaminants. While it is common in the prior art to design new crystal structures of sorbent material for scientific knowledge, it is crucial to the water treatment industry to design practical, cost efficient sorptive media.

In many applications, heavy metals may be present in minute quantities (high parts per trillion (ppt) or low parts per billion (ppb)); their presence in drinking water streams can affect human health. Many cases of lead (Pb) contamination in water have been reported because of simple chemistry changes to water that is carried through lead (Pb) pipes. Municipalities, for example, check their water quality at wells or at plants, but not at homes. When historical lead service pipes are used, lead can leach into the water causing possible harm to children and adults alike. Lead is not the only problem. The US Environmental Protection Agency (EPA) through the “Clean Water Act” and the “Safe Drinking Water Act” regulate pollutants into our environment and contaminants in our drinking water. The US EPA regulates over 90 contaminants in drinking water which includes lead, mercury, arsenic, and other heavy metals.

Sorption media must be designed to remove heavy metals such as lead, mercury, cadmium, and arsenic so that safe drinking water can be provided to families.

U.S. Pat. No. 5,053,139 discloses that certain amorphous titanium and tin silicate gels demonstrate fast kinetic uptake of a variety of heavy metals (Pb, Cd, Zn, Cr and Hg). This prior art showed that the titanosilicates can have a fast and compelling uptake of heavy metals ions. These inventions are often used in carbon block applications where the capacity of the media and kinetic rate determine how long a block can remove Pb or Hg from a water source. The combination of ion selectivities makes this invention excellent for use in point of entry and point of use applications. While this invention teaches a process for removing heavy metals, the prior art does not teach or define the maximum capacity of the media. In fact, amorphous materials are difficult to characterize because their atoms are not arranged in a periodic order like crystals.

Titanium dioxide has an array of crystal structures including rutile (prevalent) and to a less common extent, anatase. Even though this chemical is the same stoichiometrically, the anatase form of TiO₂ has a higher capacity to remove arsenic. Chemistry and structure can significantly change properties. Applying this concept to the titanosilicates of the prior art, changes in the process of making titanosilicates may produce different chemicals and properties. The process of making these materials can be altered to optimize kinetics and capacities. As titanosilicates are amorphous, it is more difficult to characterize these structures, thus alternative ways of identifying the chemical are necessary. Other prior art describes this by identifying the pore volume, but identification of the pore volume alone may be independent of capacity for contaminants.

U.S. Pat. Nos. 10,286,390, 9,764,315, and 9,744,518 disclose that certain amorphous titanium silicate with pore volumes of at least 0.3 cc/g (mL/g) while using pore shaping conditions can be used to remove heavy metals including Sr, Pb, Hg. This prior art teaches the formation of pores where the pores are held to at least 0.3 cc/g in all instances. However, these aforementioned patents teach the limit of the heavy metal removal properties to media with desorption pore volumes greater than or equal to 0.3 cc/g. Moreover, this prior art does not define the specific total capacities for heavy metals.

The prior art clearly demonstrates that an array of titanosilicates can be made with different properties.

All sorption media have a finite capacity for contaminants. These are typically called sites where the contaminants may occupy a pore, a surface, or exchange with another ion. Both single layered and multi-layered sorption can occur, but capacities are considered finite. Since a media, or mixtures of media have finite capacities, the media or chemicals can be described in terms of total capacities. Capacities are used in a variety of forms in the literature but are typically a function of the structure and the environment. Theoretical capacities are calculated, while total capacities and in-process capacities are measured. Modifications can be made to make new media with higher capacities. The same is true for titanosilicates.

Refrigerator designers need more space in their refrigerator appliances; consumers always want more space for food and beverage storage. The water filters (for ice or drinking water) can take up significant space. There is an industrial need for new media with fast kinetics and higher capacities at smaller volume so that the space a refrigerator block filter takes up is minimized. Titanosilicate media are used in many of these applications. If the capacities of the titanosilicates can be increased, the carbon block manufacturers have several choices: make smaller blocks, certify the blocks for a higher volume, or add new additives to the blocks for more removal claims. It is therefore crucial and important that new media with additional capacity be introduced.

### SUMMARY OF THE INVENTION

Bearing in mind the problems and deficiencies of the prior art, it is therefore an object of an embodiment of the present invention to provide a sorption media with a high capacity to remove heavy metals, such as lead and mercury in particular. It has been determined that the capacity of the media to remove lead is increased by at least 10% when synthesized from a titanium source that contains sulfuric acid (black liquor, titanyl sulfate (TiOSO₄)) or sulfur.

It is another embodiment to provide filter media capable of removing heavy metals affected by pH.

Another embodiment is to provide a less expensive filter media, that is at least equivalent in performance in removing heavy metals, including lead and mercury.

In another embodiment, a filter media is provided capable of adjustable lead and mercury capacity, which can be tailored to the specific requirements of a project.

In yet another embodiment, calcium hydroxide (slurry) is used to neutralize the reaction.

In another embodiment, the titanium source may not be pure titanyl sulfate (TiOSO₄); rather, the precursor from an ilmenite dissolution process, such as Ti-Fe-sulfates (TiOSO₄, Ti(SO₄)₂, FeSO₄, and the like).

Precipitation is a recommended and advantageous step in the making of the various embodiments of the present invention. In some instances, the pH of the solution is adjustable by adding high-pH inorganic additives.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a chemical equation for the production of the product of the present invention;

FIG. 2 is a listing of titanium-based stoichiometries with respect to their theoretical and measured lead capacities;

FIG. 3 is a comparison of several embodiments of the invention with respect to their lead capacities;

FIG. 4 is a comparison of several embodiments of the invention with respect to their mercury capacities;

FIG. 5 is a comparison of % salt in the embodiments graphed against the lead (Pb) capacities in mg Pb/dry g of media;

FIG. 6 shows how the media capacities can vary based on differing titanium solutions; and

FIG. 7 depicts a process schematic as one method to precipitate an embodiment of the present invention.

### DESCRIPTION OF EMBODIMENT(S)

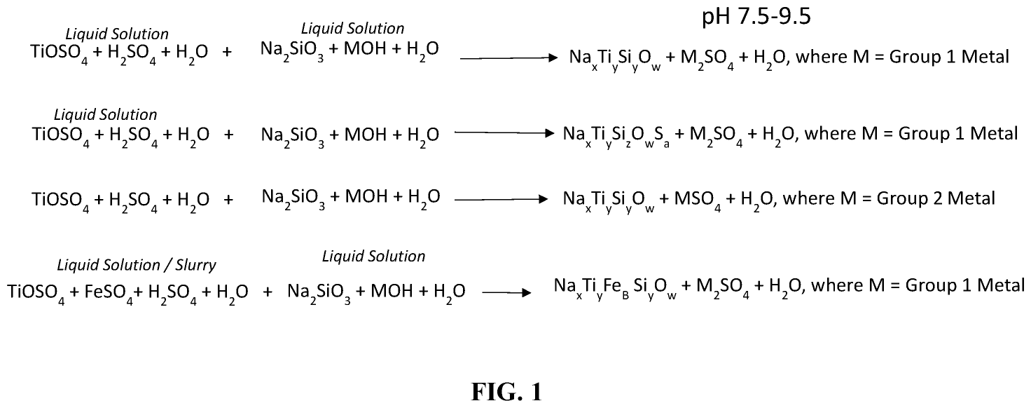

In describing the embodiment(s) of the present invention, reference will be made herein to FIGS. 1-7 of the drawings in which like numerals refer to like features of the invention.

Certain terminology is used herein for convenience only and is not to be taken as a limitation of the invention. For purposes of clarity, the same reference numbers may be used in the drawings to identify similar elements. Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

FIG. 1 contains possible chemical reactions (not balanced) for the production of the invention. Soluble titanium atoms are reacted with a mixture of a hydroxide (group 1 or group 2) and sodium silicate to produce a sodium titanosilicate and a group 1 and/or group 2 sulfate salt. The final sodium titanium silicate stoichiometry can vary depending on the ratios of the combined elements. Metal sulfate salts are produced as a byproduct along with water. By filtering and washing the product, some sulfates can be removed, while others may not be washed away. Variations in water volumes and techniques can produce final product mixtures with varying salt concentrations. The final mixture media can have a range of lead capacities. In all cases, the final product can be contacted with cationic metals, resulting in an ion exchanged product. In some embodiments the counter ion of titanosilicate may not always be sodium but could be exchanged with the Group 1 and/or Group 2 metal from the hydroxide or other base.

In previous syntheses the pH levels is generally kept around 7. However, by synthesizing the media at a higher pH, the media itself can have a higher pH. Lead in water changes forms from a divalent lead to a monovalent or particulate lead depending on the counter ions and pH level. When the media is synthesized at a higher pH, it has the ability to create local areas of basicity that does not significantly affect the pH of the water passing through a block. It has been determined that Pb is affected by the locally higher pH and is removed by precipitation and captured in the pores of the media.

The process to transform the mineral ilmenite to TiO₂ involves dissolving the ilmenite (FeTiO₃) by subjecting it to either sulfuric acid (the sulfate process) or chlorine (the chloride process). Recently, the latter process has become more desirable because it is more ecofriendly and sustainable. An unexpected result was realized when titanosilicate synthesized using titanium products from the sulfate route (with or without Fe present) were shown to have higher capacities for lead. It is likely that the presence of the sulfate or sulfur in the structure may provide higher Pb capacities because of hard-soft acid-base theory. In inorganic chemistry, it has been shown in hard-soft acid base theory that soft acids are more likely to react strongly to soft bases than hard bases. Importantly, this is not an “opposites attract” application. In chemistry, lead and mercury (and most heavy metals) are considered soft. Oxygen is considered hard, while sulfur is considered soft. There is evidence for this theory in minerals found around the world. In the environment mercury sulfide (cinnabar) and lead sulfides (galena) are viewed as minerals. The mercury and the lead could react with oxygen, which is ubiquitous in the environment, but instead these minerals exist as stable sulfides. Other minerals with hard metals (Al, Si) are almost always found as oxides. It is hypothesized that when titanosilicates are synthesized in the presence of sulfur, sulfate or sulfuric acid, some of the sulfur may remain as part of the product and react more strongly with heavy metals than a titanosilicate from the chloride process. At least one embodiment of the present invention uses hard-soft acid-base theory to have a higher capacity than other competitive products.

As depicted in FIG. 1, the reaction to make the media forms counter ion salts as a resultant. The titanosilicate is precipitated by a strong base and the pH adjusted to 7.5-10. If sodium hydroxide is used, the reaction results in the precipitation of highly soluble sodium sulfate.

Calcium hydroxide (slurry) can be used to neutralize the reaction. The byproduct of that reaction is a slightly soluble calcium sulfate. Group 1 (Na, K, Rb, etc.) and Group 2 (Mg, Ca, Sr) sulfates react with ionic lead to form insoluble lead sulfate. When part of a final product, lead ions would come in contact with the filter media of the present invention (generally stated, a mixture of titanosilicate and reactive salts) to directly precipitate lead. By controlling the salt content via washing the filter media, the apparent capacity of the media can be adjusted. Calcium sulfate would be formed from the neutralization reaction with calcium hydroxide slurry. Since calcium sulfate has a much lower solubility, it would remain even after washing. When water containing lead is passed through, lead sulfate (not soluble) is formed and calcium ions would be released. It is noted that this mechanism will work with other metals that form strong bonds to sulfates, such as, but not limited to, heavy metals.

Furthermore, the titanium source may not be pure titanyl sulfate (TiOSO₄); rather, the precursor from the ilmenite dissolution process, such as Ti-Fe-sulfates (TiOSO₄, Ti(SO₄)₂, FeSO₄, and the like). The full characterization of this “black liquor” is variable depending on the ore and digestion process. However, the black liquor can be used as a valid source of titanium ions for sodium titanosilicate media. As the pH increases, several phases of gels are observed. The iron titanium silicate product goes through several gel phases, but the final product is expected to be a sodium-titanium-iron silicate or a sodium-titanium-silicate iron oxide. Iron oxides and sulfates are known in the art to remove oxyanions, depending on the pH. Surprisingly, the incorporation of the iron into the mixture does not degrade the capacity for lead or mercury. The addition of these elements from the ilmenite ore can result in additional unexpected properties such as anion exchange functionality. Hexavalent chromium, for example, is an industrial by-product that can get into drinking water sources. There is an active need to remove hexavalent chromium (as chromate) from drinking water sources. The incorporation of iron into this invention is for the additional capacity to remove oxyanions. Essentially, this embodiment combines the co-precipitated routes to formulate a new media. Even in the presence of iron, the media has the same capacity for Pb and Hg, as without Fe.

Recent innovations in syntheses may result in different processes to make this invention. Advances in mechanochemistry, hydrothermal chemistry or other synthetic processes can be envisioned to make this product. TiO₂ can be reacted in hydrothermal synthesis to convert to titanates. Like that synthesis, titanosilicates can be made in the same process. In the presence of a sulfate, sulfur or sulfuric acid other embodiments of this invention may be envisioned. Similarly, mechanochemistry (the act of mechanically providing energy for synthesis) can be used to convert titanium dioxide or other forms of titanium.

In the embodiments of the present invention, a media is introduced for the removal of metal cations, where the media comprises a Group 1 and/or Group 2 metal-titanosilicate. The media is restricted insomuch as it has a Ti to Si molar ratio of 0.5-2, a pore volume of less than or equal to 0.25 cc/g. The media performance reveals a lead capacity of at least 280 mg/dry g at 500 ppm of Pb and/or a mercury capacity of at least 25 mg Hg/dry gram (at 50 ppm Hg). In at least one embodiment, the Group 1 metal is sodium and/or the Group 2 metal is calcium. The media may further include a Group 1 and/or Group 2 salt, which can be adjusted to optimize the removal of heavy metals. The media may be synthesized using black liquor or titanyl sulfate (TiOSO₄).

Generally, a sulfur reactant is utilized for synthesis, where the sulfur reactant is included in a titanium source. The titanium source is a precursor from an ilmenite dissolution process, including Ti-Fe-sulfates or FeSO₄. The Ti-Fe sulfates include TiOSO₄ or Ti(SO₄)₂. The titanosilicate in the metal-titanosilicate may be synthesized using titanium products from a sulfate. The media may include sulfates or oxides of Fe or Mn or other biproducts from the ilmenite dissolution process.

In at least one embodiment, the media is synthesized from a titanium source that contains sulfuric acid. Such synthesis may utilize black liquor or titanyl sulfate (TiOSO₄). Furthermore, the titanosilicate may be synthesized using titanium products from a sulfate.

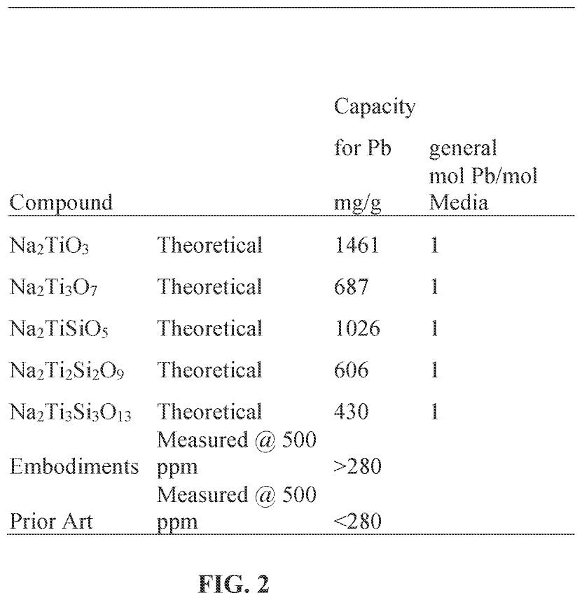

FIG. 2 is a listing of hypothetical titanium-based stoichiometries. The theoretical capacities for lead are calculated. Unrealized changes such as lattice distortions, holes, dislocations, dopants, and substitutions could change these capacities for the better or worse. In all instances, the embodiments in the present invention have a measured total capacity over 280 mg/g for Pb. It has been shown that the prior art has a capacity of less than 280 mg/g, which demonstrates that the measurable capacities are not directly tied to the theoretical capacity or stoichiometry. It also demonstrates that the embodiments of the present invention have measurable greater capacity that is not tied to the stoichiometry.

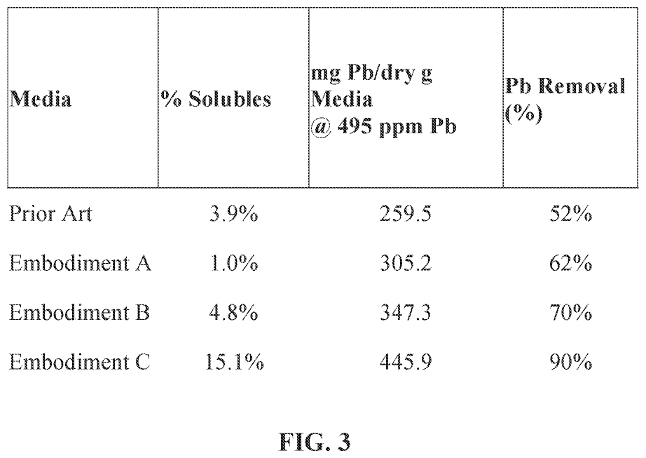

FIG. 3 is a comparison of several embodiments of the invention with respect to their lead capacities in comparison to competitive material in the marketplace. Embodiments A-C represent variations of the present invention and the varying fabrication processes. All embodiments were synthesized using titanylsulfate solution, but have different levels of soluble salts. Embodiment A has 1% of solubles, Embodiment B has 4.8% solubles, and Embodiment C has 15.1% solubles. As demonstrated by the results, the capacities of the embodiments will differ. For example, Embodiment A has a capacity of 305.2 mg Pb/dry gram of media. This is an unexpected result, because it was anticipated that the filter media of the prior art would have the same capacity as that utilized in U.S. Pat. No. 5,053,139 Material 2, which has a much lower capacity of 259.5 mg Pb per dry gram of media, according to the studies presented.

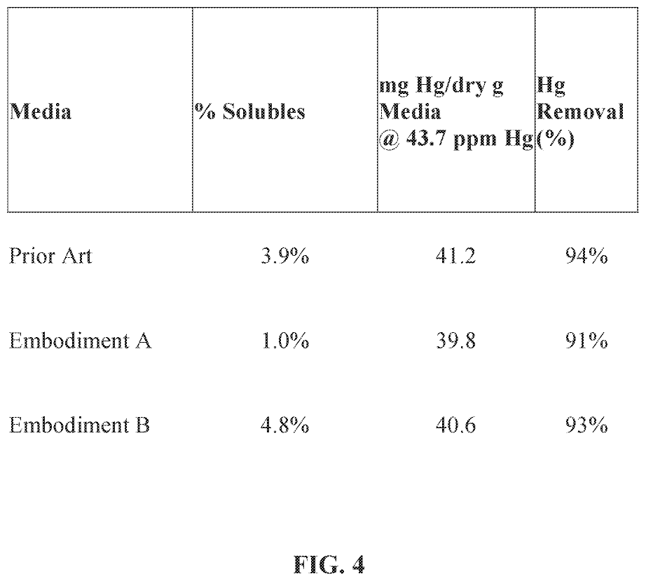

FIG. 4 is a comparison of several embodiments of the invention with respect to their mercury capacities. Embodiments A and B maintain at least the same capacity as the prior art, while exhibiting a substantial increase in lead capacities.

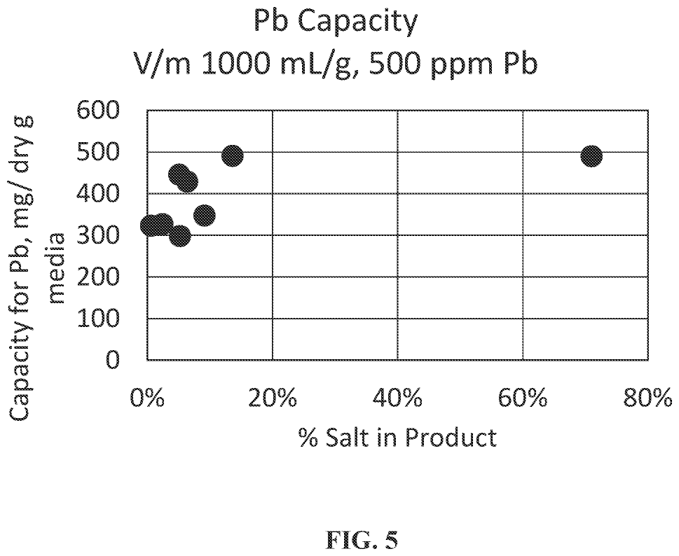

FIG. 5 is an example of the embodiments where the salt is altered in the product. This can be completed by different levels of washing or altering the base used to precipitate the embodiments. A significant capacity increase is depicted from 0% salt to approximately 16% salt, wherein the capacity increases from 300 mg/g to around 500 mg/g. The trend is limited as a plateau is observed beyond 18% salts.

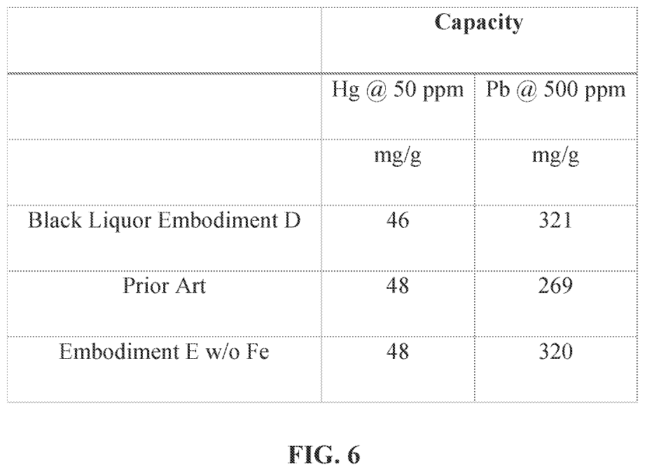

FIG. 6 shows how the media capacities can vary based on differing titanium solutions. A 100% reaction using the “black liquor” results in the highest lead and mercury capacities. In comparison, Embodiment D was synthesized using black liquor. Embodiment E was synthesized with a TiOSO₄ solution.

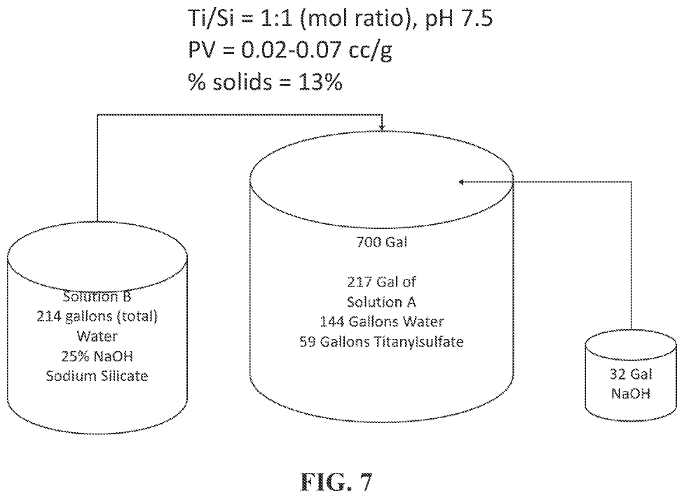

FIG. 7 depicts a process schematic as one method to precipitate an embodiment of the present invention. This process is performed at a lower pH (7.5). A solution (B) incorporating 214 gallons includes water, 25% NaOH, and sodium silicate. This solution is then mixed with 144 gallons of water and 59 gallons of titanyl sulfate solution to which 32 gallons of sodium hydroxide (NaOH) is added. Note that the volumetric numbers are calculated based on having a Ti to Si ratio of 1:1 (mol). Other embodiments will adjust the ratio of Ti to Si from 0.5 to 2.0, depending on the desired outcome. The resulting pore volumes are between 0.02-0.07 cc/g, with advantageous Pb capacities empirically shown to be higher than the baseline media.

In a first process, titanyl sulfate (produced from a sulfate process) is added to deionized water into vessel A. Sodium silicate is added to 50% sodium hydroxide and deionized water into vessel B. The amounts of the chemicals are added such that the ratio of Ti to Si is approximately 1:1 based on moles. Sodium hydroxide and water can be varied to achieve predetermined desired outcomes (pH, percent solids in the slurry, etc.). The contents of both vessels are then stirred. The base mixture of vessel B is then added slowly to vessel A over a period of 30 minutes to 95 minutes. The pH is measured to be approximately 1.58. The pH is then adjusted with 50% NaOH until the pH is between 8.0 and 9.05 standard units. The sample is mixed for 10 minutes. The mixer is turned off and the solution settles for 1 hour. The pH is rechecked to be between 8.5 and 9.5. The solution is then filtered and washed with water to a conductivity of 2500 MS (2500 μS/cm). The resulting filtered product is then dried. If desired, filtrate may then made into a cake. The resulting cake can be reslurried and dried via spray drying. The resulting filtered product is then dried. The pore volume of this media has been measured to be less than 0.3 cc/g.

In another process embodiment, the titanium source is derived from a solution/suspension containing dissolved ilmenite liquor (black liquor). The titanium source may contain iron, sulfate, sulfuric acid, titanium, manganese and other impurities which may be found in the contents of ilmenite. The liquor is diluted with water and put into a first vessel. Sodium silicate and sodium hydroxide are weighed into a second vessel. The molar ratio of titanium to silicon is ideally between 0.5 to 2.0. If added in this way, the pore volume will be significantly smaller than 0.3 cc/g. The small pore volume as calculated to be on the order of less than 0.15 cc/g is an unexpected result because intuitively a higher pore volume would suggest more sites for Pb removal. However, this data shows under circumstances illustriously demonstrated by embodiments of the present invention that a small pore volume can also achieve a high capacity.

In at least one embodiment, the present invention includes a process of removing heavy metals comprising contacting a solution containing heavy metals with a media comprising a Group 1 and/or Group 2 metal-titanosilicate having a Ti to Si molar ratio of 0.5-2, a pore volume of approximately less than or equal to 0.25 cc/g, and a lead capacity of at least 280 mg/ dry g at 500 ppm of Pb and/or a Hg capacity of at least 25 mg/g at 30 ppm of Hg.

The method of producing a sorbent for the removal of ions from a liquid stream, includes: reacting soluble titanium with a mixture of a hydroxide and sodium silicate to produce a resultant product of titanosilicate and a Group 1 and/or Group 2 sulfate salt; and filtering and washing the resultant product to remove sodium sulfate. The process further includes combining TiOSO₄+H₂SO₄+H₂O with Na₂SiO₃+NaOH+H₂O. In this process, a calcium hydroxide slurry is an option to neutralize the reaction. The soluble titanium may be obtained from Ti-Fe-sulfates.

Further considerations in producing the sorbent include, but are not limited to: a) where the product is spray dried to a size of 25-80 μm D50; b) where iron or other transition metals are added to the process to reduce cost; c) where the reaction is done at room temperature; and d) where TiO₂ can be dissolved at greater than 200° C. and then reacted with sodium silicate and sodium hydroxide to produce the product.

The capacity of the media can be measured by contacting 100 dry mg of the media to a solution containing approximately 500 parts per million (ppm) of Pb²⁺. The lead solution is made by dissolving lead nitrate into deionized water. The pH need not be adjusted. The sample is placed on a shaker table between 10 and 16 hours. The solution is filtered with a 0.45 μm filter and analyzed for Pb. The capacity is calculated according to:

Q=(C₀−C_{f})*(V/m)/1000
where Q is capacity in mg of contaminant sorbed per dry gram of media;
C₀ is the concentration of contaminant in the initial solution (ppm);
C_{f} is the final concentration of contaminant in the reacted solution (ppm);
V is the volume of solution use in mL; and
m is the mass of dry media used in grams.

The media is used as-is but a calculation may be performed to standardize for moisture. This process may be used to evaluate multiple media.

In at least one embodiment of the present invention, the sorbent may be produced by: a) reacting soluble titanium with a mixture of a hydroxide and sodium silicate to produce a resultant product of titanosilicate and a group 1 and/or group 2 sulfate salt; and filtering and washing the resultant product to remove sodium sulfate, wherein the titanium source is obtained from Ti-Fe-sulfates.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A media for the removal of metal cations comprising a Group 1 and/or Group 2 metal-titanosilicate having a Ti to Si molar ratio of 0.5-2, a pore volume of less than or equal to 0.25 cc/g, and a lead capacity of at least 280 mg/dry g at 500 ppm of Pb.

2. The media of claim 1 having a mercury capacity of at least 25 mg Hg/dry gram at 50 ppm Hg.

3. The media of claim 1 where the Group 1 metal is sodium.

4. The media of claim 1 where the Group 2 metal is calcium.

5. The media of claim 1 including a sulfur reactant utilized for synthesis.

6. The media of claim 5 wherein said sulfur reactant is included in a titanium source.

7. The media of claim 1 wherein said media is synthesized using black liquor and/or titanyl sulfate (TiOSO₄).

8. The media of claim 1 wherein titanosilicate in said metal-titanosilicate is synthesized using titanium products from a sulfate.

9. The media of claim 6 wherein the titanium source is a precursor from an ilmenite dissolution process, including Ti-Fe-sulfates or FeSO₄.

10. The media of claim 9 wherein said Ti-Fe sulfates include TiOSO₄ or Ti(SO₄)₂.

11. The media of claim 1 including a Group 1 and/or Group 2 salt.

12. The media of claim 1 containing sulfates or oxides of Fe and/or Mn or other biproducts from an ilmenite dissolution process.

13. The media of claim 11 where said Group 1 or Group 2 salt is adjusted to optimize the removal of heavy metals.

14. A process of removing heavy metals comprising contacting a solution containing heavy metals with a media comprising a Group 1 and/or Group 2 metal-titanosilicate having a Ti to Si molar ratio of 0.5-2, a pore volume of less than or equal to 0.25 cc/g, and a lead capacity of at least 280 mg/dry g at 500 ppm of Pb.

15. The process of claim 14 where the media has a Hg capacity of at least 25 mg/g at 30 ppm of Hg.

16. A method of producing a sorbent for the removal of ions from a liquid stream, comprising:
reacting soluble titanium with a mixture of a hydroxide and sodium silicate to produce a resultant product of titanosilicate and a group 1 and/or group 2 sulfate salt; and
filtering and washing said resultant product to remove the metal sulfate salt.

17. The method of claim 16 wherein said step of reacting soluble titanium with a mixture of a hydroxide and sodium silicate to produce a resultant product of titanosilicate and a group 1 and/or group 2 sulfate salt includes combining TiOSO₄+H₂SO₄+H₂O with Na₂SiO₃+NaOH+H₂O.

18. The method of claim 16 including using a calcium hydroxide slurry to neutralize the reaction.

19. The method of claim 16 wherein said titanium is obtained from Ti-Fe-sulfates.
